(19) United States
(12) Patent Application Publication
(10) Pub. No.: US 2023/0045487 A1
(43) Pub. Date: Feb. 9, 2023

(54) ANOMALY DETECTION USING TENANT CONTEXTUALIZATION IN TIME SERIES DATA FOR SOFTWARE-AS-A-SERVICE APPLICATIONS

(71) Applicant: SAP SE, Walldorf (DE)

(72) Inventor: Shashank Mohan Jain, Karnataka (IN)

(21) Appl. No.: 17/392,978

(22) Filed: Aug. 3, 2021

(51) Int. Cl. H04L 29/06

(52) U.S. Cl. CPC H04L 63/1425

(57) ABSTRACT

A system may include a historical time series data store that contains electronic records associated with Software-as-a-Service (“SaaS”) applications in a multi-tenant cloud computing environment (including time series data representing execution of the SaaS applications). A monitoring platform may retrieve time series data for the monitored SaaS application from the historical time series data store and create tenant vector representations associated with the retrieved time series data. The monitoring platform may then provide the retrieved time series data and tenant vector representations together as final input vectors to an autoencoder to produce an output including at least one of a tenant-specific loss reconstruction and tenant-specific thresholds for the monitored SaaS application. The monitoring platform may utilize the output of the autoencoder to automatically detect an anomaly associated with the monitored SaaS application.

### BACKGROUND

An enterprise may use on-premises systems and/or a cloud computing environment to run applications and/or to provide services. For example, cloud-based applications may be used to process purchase orders, handle human resources tasks, interact with customers, etc. Moreover, a cloud computer environment may provide for an automating deployment, scaling, and management of Software-as-a-Service (“SaaS”) applications. As used herein, the phrase “SaaS” may refer to a software licensing and delivery model in which software may be licensed on a subscription basis and be centrally hosted (also referred to as on-demand software, web-based or web-hosted software). Note that a “SaaS” application might also be associated with Infrastructure-as-a-Service (“IaaS”), Platform-as-a-Service (“PaaS”), Desktop-as-a-Service (“DaaS”), Managed-Software-as-a-Service (“MSaaS”), Mobile-Backend-as-a-Service (“MBaaS”), Datacenter-as-a-Service (“DCaaS”), Information-Technology-Management-as-a-Service (“ITMaaS”), etc. Note that a multi-tenant cloud computing environment may execute such applications for a variety of different customers or tenants.

In some cases, a cloud provider will want to detect anomalies in SaaS applications that are currently executing. For example, the provider might restart SaaS applications or provide additional computing resources to SaaS applications when an anomaly is detected to improve performance. It would therefore be desirable to automatically detect anomalies in a multi-tenant cloud computing environment in an efficient and accurate manner.

### SUMMARY

According to some embodiments, methods and systems may facilitate automatic anomaly detection using tenant contextualization in time series data for a SaaS application. The system may include a historical time series data store that contains electronic records associated with Software-as-a-Service (“SaaS”) applications in a multi-tenant cloud computing environment (including time series data representing execution of the SaaS applications). A monitoring platform may retrieve time series data for the monitored SaaS application from the historical time series data store and create tenant vector representations associated with the retrieved time series data. The monitoring platform may then provide the retrieved time series data and tenant vector representations together as final input vectors to an autoencoder to produce an output including at least one of a tenant-specific loss reconstruction and tenant-specific thresholds for the monitored SaaS application. The monitoring platform may utilize the output of the autoencoder to automatically detect an anomaly associated with the monitored SaaS application.

Some embodiments comprise: means for retrieving, by a computer processor of a monitoring platform, time series data representing execution of Software-as-a-Service (“SaaS”) applications in a multi-tenant cloud computing environment; means for creating tenant vector representations associated with the retrieved time series data; means for providing the retrieved time series data and tenant vector representations together as final input vectors to an autoencoder to produce an output including at least one of a tenant-specific loss reconstruction and tenant-specific thresholds for the monitored SaaS application; and means for utilizing the output of the autoencoder to automatically detect an anomaly associated with the monitored SaaS application.

Some technical advantages of some embodiments disclosed herein are improved systems and methods associated with automatic anomaly detection using tenant contextualization in time series data for a SaaS application in an efficient and accurate manner.

### BRIEF DESCRIPTION OF THE DRAWINGS

FIG. 1 is a multi-tenant cloud computing environment in accordance with some embodiments.

FIG. 2 illustrates an autoencoder system according to some embodiments.

FIG. 3 is a Long Short-Term Memory (“LSTM”) system in accordance with some embodiments.

FIG. 4 illustrates a LSTM method according to some embodiments.

FIG. 5 illustrates a potential SaaS application time series data point problem.

FIG. 6 is a high-level architecture for a system in accordance with some embodiments.

FIG. 7 illustrates a system with one-hot encoding according to some embodiments.

FIG. 8 illustrates a system with a vector creation algorithm in accordance with some embodiments.

FIG. 9 illustrates a tenant contextualization method according to some embodiments.

FIG. 10 illustrates a solution to the SaaS application time series data point problem according to some embodiments.

FIG. 11 is a human machine interface display in accordance with some embodiments.

FIG. 12 is an apparatus or platform according to some embodiments.

FIG. 13 illustrates a contextualization database in accordance with some embodiments.

FIG. 14 illustrates a handheld tablet computer according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components, and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

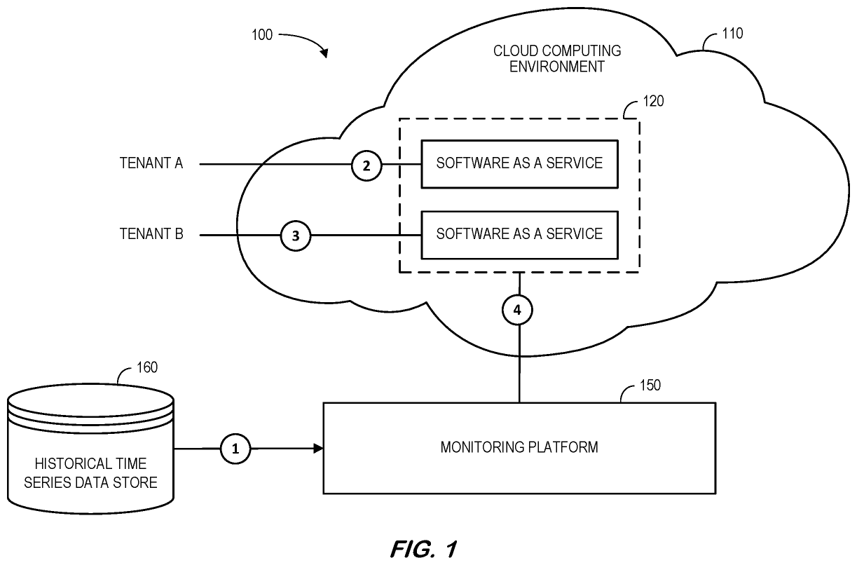

FIG. 1 is a system 100 for a multi-tenant cloud computing environment 110 in accordance with some embodiments. A monitoring platform 150 may be used to detect anomalies in the cloud computing platform 110 based on information in a historical time series data store 160 retrieved at (1). When tenant A executes a SaaS application 120 at (2) and tenant B executes another instance of the SaaS application 120 at (3). At (4), the monitoring platform 150 examines characteristics of the currently executing SaaS applications 120 to detect anomalies.

In classical machine learning, the anomaly detection at (4) might be performed using methods such as Auto Regressive Moving Average (“ARMA”), Auto Regressive Integrated Moving Average (“ARIMA”), a Support Vector Machine (“SVM”), etc. on the data in the historical time series data store 160. With the advent of deep learning, the focus shifted to using neural networks and, in particular, Recurrent Neural Networks (“RNN”) to study and model sequential data like language and time series. RNN can suffer from a classic problem called “vanishing gradients” where the network stops learning when a sequence becomes too large. To get rid of the vanishing gradients problem, Long Short-Term Memory (“LSTM”) networks can be successful for modelling sequential data using multiple time steps.

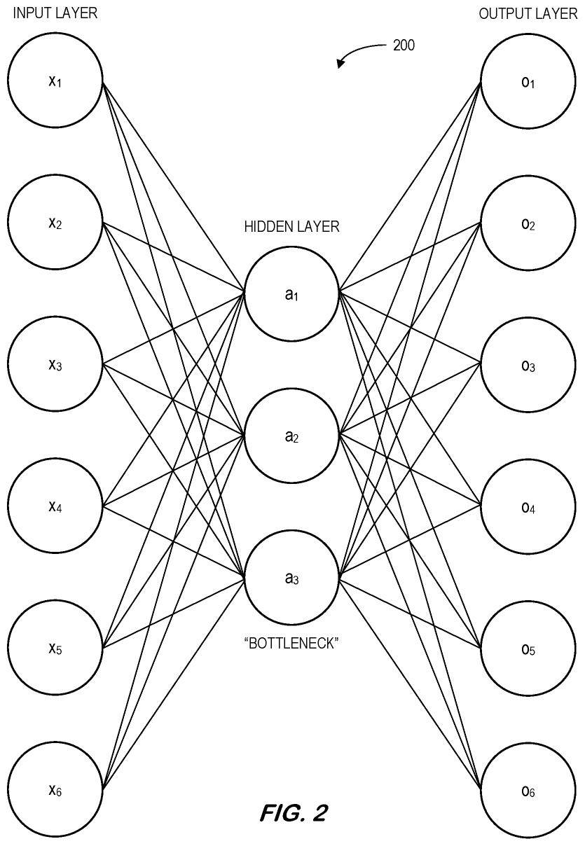

In the domain of anomaly detection, the normal LSTM networks might not provide adequate performance because the labelled data is usually skewed (that is, most of the data is normal and there is not a lot of anomalous data). An adaption was therefore made using methods such as LSTM autoencoders. An “autoencoder” is a neural network model that seeks to learn a compressed representation of an input. FIG. 2 illustrates an autoencoder system 200 including an input layer (x₁ through x₆), a hidden layer “bottleneck” (a₁ through a₃), and an output layer (o₁ through o₆) according to some embodiments. Autoencoders are an unsupervised learning method, although, technically, they may be trained using supervised learning methods (referred to as a “self-supervised” approach. Autoencoders are typically trained as part of a broader model that attempts to recreate the input. The design of the autoencoder system 200 makes this challenging by restricting the architecture to the bottleneck at the midpoint of the model, from which the reconstruction of the input data is performed. As can be seen in FIG. 2, the input is reconstructed via the bottleneck layer. The bottleneck layer learns the most important features of the data (and forgets the unnecessary details in the input). When applied to sequential data, the autoencoder system 200 will learn the compressed representations of the sequence of data (such as a time series of data having a certain length). This means that the system will learn important patterns (e.g., trends, seasonality, etc.) that might be present in the time series data.

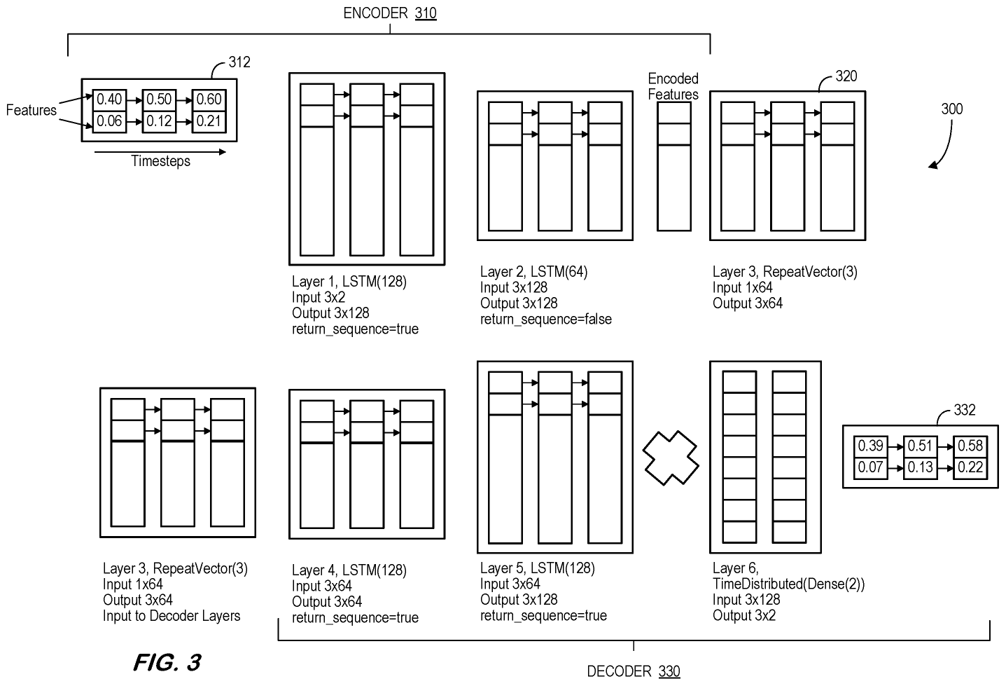

A sample representation of a LSTM encoder system 300 having an encoder portion 310 and a decoder portion 330 is shown in FIG. 3 in accordance with some embodiments. The decoder portion 330 operates on an input sample 312 of time steps via layers 1 and 2. A middle layer 320 (layer 3 which acts as a “bridge” between the encoder portion 310 and the decoder portion 330) learns the important features of the sequences and is input to the decoder portion 330. The decoder portion 330 includes layers 4 and 5 followed by a matrix multiplication with layer 6 to create an output 332 that is close to the input sample 312.

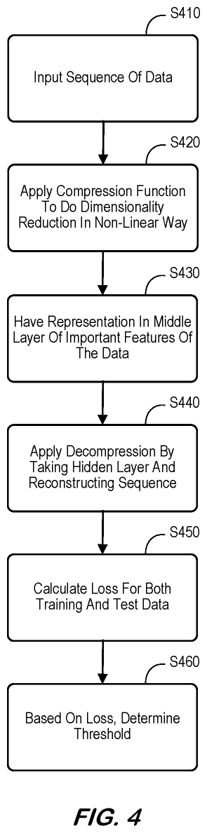

According to some embodiments, the LSTM encoder system 300 trains a network using training data that does not have anomalies. The autoencoder may learn the representation of the normal data in terms of its trends, seasonality, and similar features. FIG. 4 illustrates a LSTM method according to some embodiments. At S410, the system may take an input as a sequence of data. At S420, the system may apply a compression function on the sequence of data to do a dimensionality reduction (e.g., in a non-linear way). As a result, at S430 the system may have a representation in the middle layer of the important features of the data. At S440, the system may apply decompression by taking the hidden layer and reconstructing the sequence. At S450, the system can then calculate the loss for both the training and test data. Based on the loss, the system may determine a threshold for the loss at S460 (this means that if network is able to reconstruct the sequence data to this threshold there is no anomaly but anything beyond that threshold is considered a detection of an anomaly). This process is referred to as a “loss reconstruction” method.

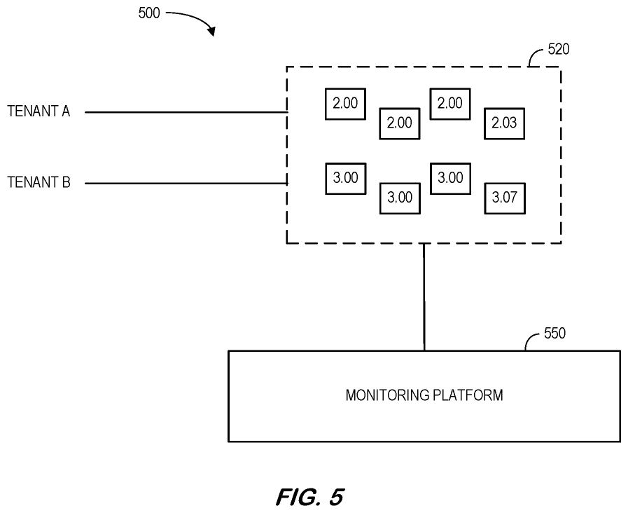

Now consider a scenario with multiple tenants (who each access the same SaaS or similar type of application) that uses this kind of network to determine anomalies from the data. Such an approach may create serious problems. For example, a system might support both tenant A and tenant B which each consume the same SaaS application. For tenant A, one hundred requests-per-minute might be normal behavior while for tenant B that same value is an anomaly. FIG. 5 illustrates 500 a potential SaaS application time series data point problem. In particular, a monitoring platform 550 is watching a cloud computing environment generating time series data 520 for tenant A and tenant B (with tenant A generating data points 2.00, 2.00, 2.00, and 2.03 and tenant B generating data points 3.00, 3.00, 3.00, 3.00, and 3.07). If the monitoring platform 550 is trained using all of the time series data 520 together (without taking tenant context into account), all data of tenant B might be flagged as anomalous including “3.00” which is a normal value for tenant B.

That is, the LSTM autoencoder currently has no information about tenant context. The system instead works instead at a global setting (which is not optimal). In addition to capturing temporal context in a time series (e.g., seasonality and trends), some embodiments described herein may also take into account a tenant context. That is, the network may be extended to accommodate a tenant context within the autoencoder LSTM setting. This may imply that the network learns not only about a sequence but also about a sequence within the context of a tenant.

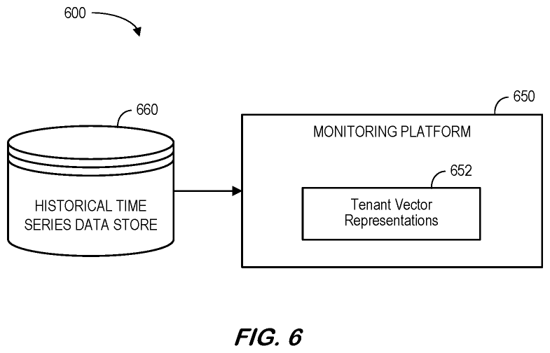

According to some embodiments, a system may create a tenant vector representation (note that this vector might be one hot encoded or may be derived from other tenant features that are specific to a tenant). For example, FIG. 6 is a high-level block diagram of a system 600 according to some embodiments. A historical time series data store 660 coupled to a monitoring platform 650 captures (e.g., via electronic records) sequences of values associated with execution of SaaS application. The monitoring platform 650 may then automatically create tenant vector representations 652 for that data. A used herein, the term “automatically” may refer to a device or process that can operate with little or no human interaction.

According to some embodiments, devices, including those associated with the system 600 and any other device described herein, may exchange data via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The elements of the system 600 may store data into and/or retrieve data from various data stores (e.g., the storage device 660), which may be locally stored or reside remote from the monitoring platform 650. Although a single monitoring platform 650 is shown in FIG. 6, any number of such devices may be included. Moreover, various devices described herein might be combined according to embodiments of the present invention. For example, in some embodiments, the historical time series data store 660 and monitoring platform 650 might comprise a single apparatus. Some or all of the system 600 functions may be performed by a constellation of networked apparatuses, such as in a distributed processing or cloud-based architecture.

A user (e.g., a cloud operator or administrator) may access the system 600 via a remote device (e.g., a Personal Computer (“PC”), tablet, or smartphone) to view data about and/or manage operational data in accordance with any of the embodiments described herein. In some cases, an interactive graphical user interface display may let an operator or administrator define and/or adjust certain parameters (e.g., to set up or adjust various LSTM parameters) and/or receive automatically generated recommendations, results, and/or alerts from the system 600.

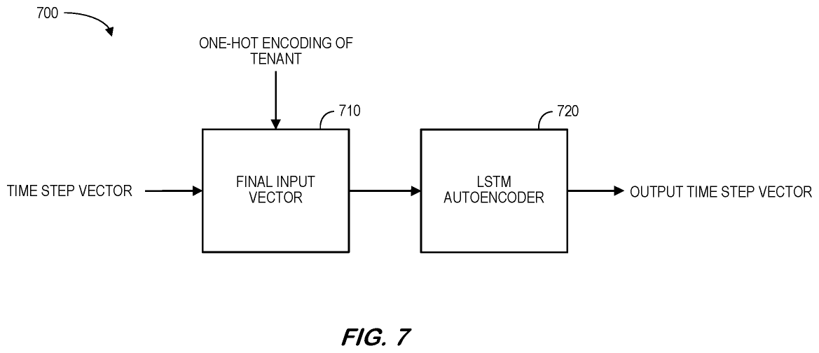

Note that the monitoring platform 650 might generate the tenant vector representations in a number of different ways. For example, FIG. 7 illustrates a system 700 in which a final input vector 710 for an LSTM autoencoder 720 is created based on a time step vector combined with “one-hot encoding” according to some embodiments. As used herein, the phrase “one-hot encoding” may refer to a technique in which a set of vectors each include a group of bits with a single high bit and all the others low (“ . . . 0001” might refer to tenant A while “ . . . 0010” refers to tenant B). Note that any one-hot encoding embodiment described herein could instead be associated with one-cold encoding (a single low bit) or other similar techniques. The LSTM autoencoder 720 can then generate an output time step vector based on the final input vector 710 (which includes tenant context).

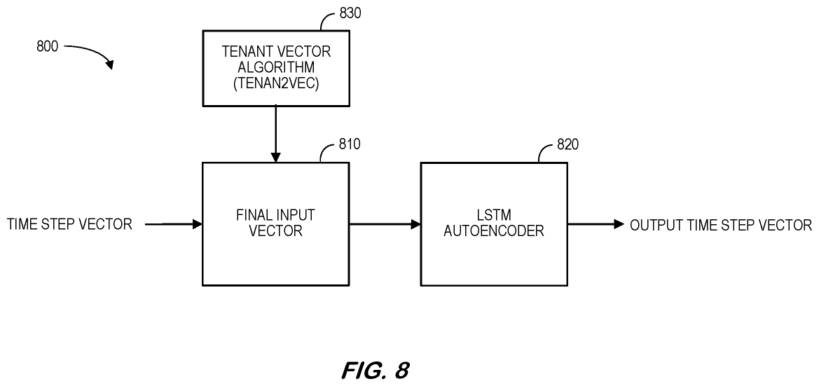

FIG. 8 illustrates a system 800 with a vector creation algorithm in accordance with some embodiments. In this case, a final input vector 810 for an LSTM autoencoder 820 is created based on a time step vector combined with information from a tenant vector algorithm 830 according to some embodiments. For example, the tenant vector algorithm 830 may use a methodology “tenant2vec” to capture tenant context. “Tenant2vec” might be, according to some embodiments, similar to the “word2vec” technique for natural language processing. The word2vec algorithm uses a neural network model to learn word associations from a large corpus of text. Word2vec represents each distinct word with a particular list of numbers called a vector. The vectors are chosen such that a simple mathematical function (the cosine similarity between the vectors) indicates a level of semantic similarity between the words represented by those vectors. Similarly, the tenant vector algorithm 830 may take into account tenant context using tenant-specific features such as an account identifier, a subaccount identifier, revenue information, usage data (e.g., how many subscriptions the tenant has), etc. The LSTM autoencoder 820 can then generate an output time step vector based on the final input vector 810 (which includes tenant context).

By using the methodology of FIG. 7 or 8 or a similar technique, embodiments may translate a representation of the tenant into a vector form. Note that a length of the tenant vector representations may be the same as the size of a single time step vector (to facilitate input to the LSTM autoencoder). The initial input vector can then be enhanced by a simple vector addition to a tenant vector representation, and a final input vector may be generated and fed into the LSTM autoencoder. The autoencoder will then try to compress the sequence (which is enhanced with tenant-specific data), and the loss is calculated. Because the tenant encoding is now performed, the system can generate tenant-specific loss reconstruction and thresholds.

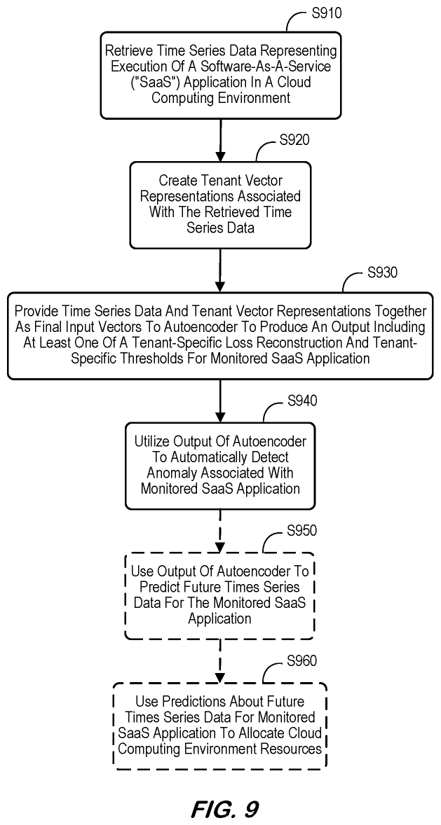

FIG. 9 illustrates a method to facilitate automatic anomaly detection using tenant contextualization in time series data for a SaaS application according to some embodiments. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S910, a computer processor of a monitoring platform may retrieve time series data representing execution of SaaS applications in a multi-tenant cloud computing environment. At S920, the monitoring platform may create tenant vector representations associated with the retrieved time series data. According to some embodiments, the creation of the tenant vector representations is performed using one-hot encoding or a tenant-to-vector algorithm (e.g., associated with an account identifier, a sub-account identifier, revenue information, usage data, etc.). Note that a length of the tenant vector representations may be equal to a length of the time series data.

At S930, the monitoring platform may provide the retrieved time series data and tenant vector representations together as final input vectors to an autoencoder to produce an output including at least one of a tenant-specific loss reconstruction and tenant-specific thresholds for the monitored SaaS application. The autoencoder may, for example, comprise a LSTM autoencoder.

At S940, the monitoring platform may utilize the output of the autoencoder to automatically detect an anomaly associated with the monitored SaaS application. For example, the monitoring platform may be configured to transmit an anomaly detection signal (e.g., based on tenant-specific thresholds and current time series values for the SaaS application being monitored). Note that the output of the autoencoder might be associated with trends, seasonality, usage cycles, peak usage time periods (e.g., requests from tenant B spike between 2:00 pm and 3:00 pm), etc. Optionally at S950 (as illustrated by dashed lines in FIG. 9), the output of the autoencoder may be associated with predictions about future times series data for the monitored SaaS application. Optionally at S960, the predictions about future times series data for the monitored SaaS application are used to allocate computing resources of the multi-tenant cloud computing environment.

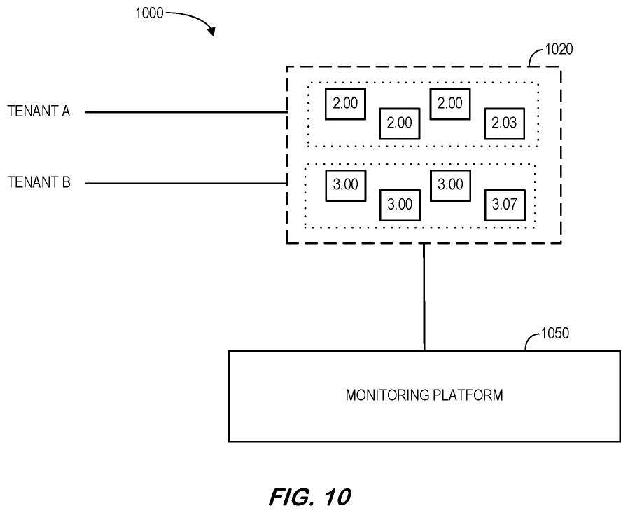

FIG. 10 illustrates 1000 a solution to the SaaS application time series data point problem according to some embodiments (in contrast to FIG. 5). As before, a monitoring platform 1050 is watching a cloud computing environment generating time series data 1020 for tenant A and tenant B (with tenant A generating data points 2.00, 2.00, 2.00, and 2.03 and tenant B generating data points 3.00, 3.00, 3.00, 3.00, and 3.07). The monitoring platform 550 is trained using tenant-specific context of the time series data 1020 (as illustrated by the dotted lines in FIG. 10). If, for example, 2% is the anomaly threshold then tenant A will pass as normal data and tenant B will be flagged as anomalous (because the “3.07” value will cross the 2% threshold for tenant B).

As new data becomes available with new tenants, the model can be updated to learn the tenant specific representations of the specific time series sequences for the new tenant. Although some embodiments described herein provide anomaly detection for a tenant, note that a similar approach can be used to provide time series prediction on a per-tenant basis as well.

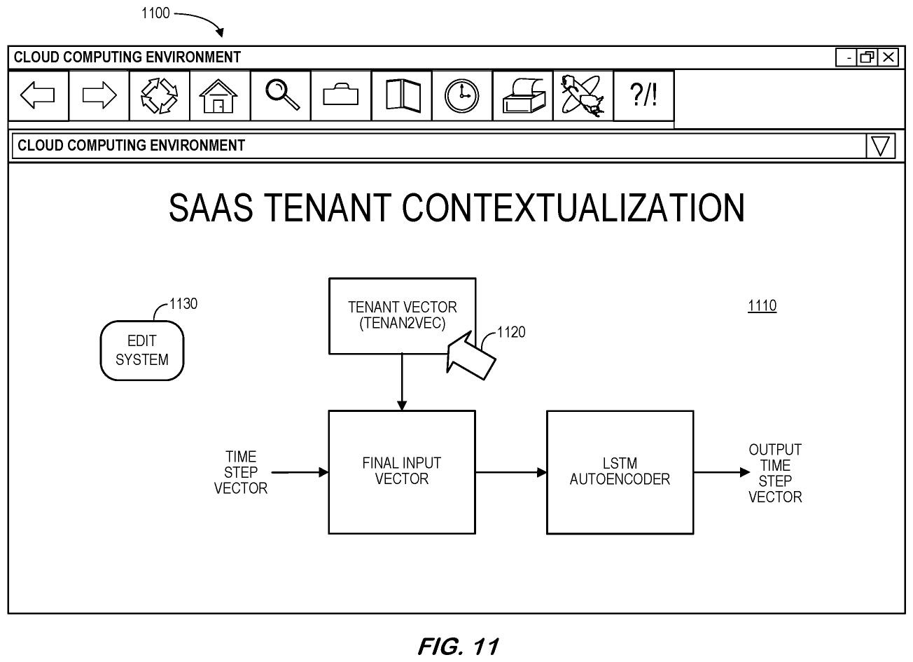

FIG. 11 is a human machine interface display 1100 in accordance with some embodiments. The display 1100 includes a graphical representation 1110 or dashboard that might be used to manage or monitor a SaaS tenant contextualization framework (e.g., associated with a multi-tenant cloud provider). In particular, selection of an element (e.g., via a touchscreen or computer mouse pointer 1120) might result in the display of a popup window that contains configuration data. The display 1100 may also include a user selectable “Edit System” icon 1130 to request system changes (e.g., to investigate or improve system performance).

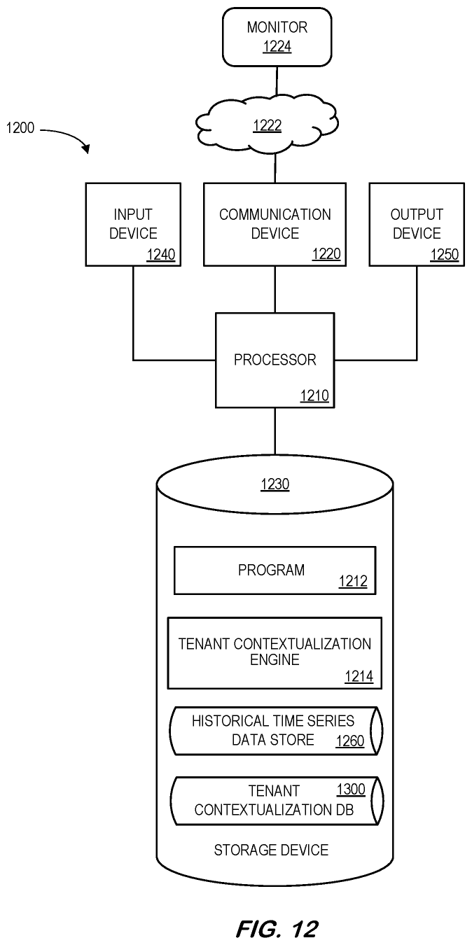

Note that the embodiments described herein may be implemented using any number of different hardware configurations. For example, FIG. 12 is a block diagram of an apparatus or platform 1200 that may be, for example, associated with the system 600 of FIG. 6 (and/or any other system described herein). The platform 1200 comprises a processor 1210, such as one or more commercially available CPUs in the form of one-chip microprocessors, coupled to a communication device 1220 configured to communicate via a communication network (not shown in FIG. 12). The communication device 1220 may be used to communicate, for example, with one or more remote user platforms or a monitor 1224 (e.g., that monitors for SaaS application anomalies) via a communication network 1222. The platform 1200 further includes an input device 1240 (e.g., a computer mouse and/or keyboard to input data about model training and/or vector algorithms) and an output device 1250 (e.g., a computer monitor to render a display, transmit recommendations or alerts, and/or create monitoring reports). According to some embodiments, a mobile device and/or PC may be used to exchange data with the platform 1200.

The processor 1210 also communicates with a storage device 1230. The storage device 1230 can be implemented as a single database or the different components of the storage device 1230 can be distributed using multiple databases (that is, different deployment data storage options are possible). The storage device 1230 may comprise any appropriate data storage device, including combinations of magnetic storage devices (e.g., a hard disk drive), optical storage devices, mobile telephones, and/or semiconductor memory devices. The storage device 1230 stores a program 1212 and/or tenant contextualization engine 1214 for controlling the processor 1210. The processor 1210 performs instructions of the programs 1212, 1214, and thereby operates in accordance with any of the embodiments described herein. For example, the processor 1210 may retrieve time series data for the monitored SaaS application from a historical time series data store 1260 and create tenant vector representations associated with the retrieved time series data. The processor 1210 may then provide the retrieved time series data and tenant vector representations together as final input vectors to an autoencoder to produce an output including at least one of a tenant-specific loss reconstruction and tenant-specific thresholds for the monitored SaaS application. The processor 1210 may utilize the output of the autoencoder to automatically detect an anomaly associated with the monitored SaaS application.

The programs 1212, 1214 may be stored in a compressed, uncompiled and/or encrypted format. The programs 1212, 1214 may furthermore include other program elements, such as an operating system, clipboard application, a database management system, and/or device drivers used by the processor 1210 to interface with peripheral devices.

As used herein, data may be “received” by or “transmitted” to, for example: (i) the platform 1200 from another device; or (ii) a software application or module within the platform 1200 from another software application, module, or any other source.

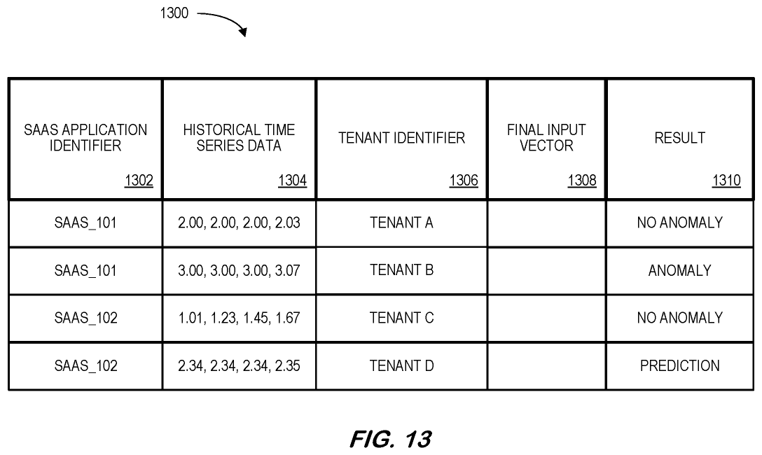

In some embodiments (such as the one shown in FIG. 12), the storage device 1230 further stores the historical time series data store 1260 and a tenant contextualization database 1300. An example of a database that may be used for the platform 1200 will now be described in detail with respect to FIG. 13. Note that the database described herein is only one example, and additional and/or different data may be stored therein. Moreover, various databases might be split or combined in accordance with any of the embodiments described herein.

Referring to FIG. 13, a table is shown that represents the tenant contextualization database 1300 that may be stored at the platform 1200 according to some embodiments. The table may include, for example, entries identifying SaaS applications being monitored in a multi-tenant cloud computing environment. The table may also define fields 1302, 1304, 1306, 1308, 1310 for each of the entries. The fields 1302, 1304, 1306, 1308, 1310 may, according to some embodiments, specify: a SaaS application identifier 1302, historical time series data 1304, a tenant identifier 1306, a final input vector 1308, and a result 1310. The tenant contextualization database 1300 may be created and updated, for example, when a new SaaS application is modeled, a new tenant is added to a system, etc.

The SaaS application identifier 1302 might be a unique alphanumeric label or link that is associated with a currently executing SaaS application that is being monitored for anomalies. The historical time series data 1304 may be used to train an LSTM autoencoder. The tenant identifier 1306 may be used to create a tenant vector representation. The historical time series data 1304 and tenant vector representation can then be combined to form the final input vector 1308 (which is then used to train the LSTM autoencoder). The result 1310 is based on an output of the trained LSTM autoencoder (and current time series values) and might indicate, for example, that no anomaly is currently detected for a SaaS application, an anomaly is currently detected for a particular tenant, a prediction of future time series data, etc.

In this way, embodiments may facilitate automatic anomaly detection using tenant contextualization in time series data for a SaaS application in an efficient and accurate manner. Since this is a generic approach, it can work for any SaaS enabled platform and services where multi-tenancy is enabled. Generation of the tenant context vector can also be generalized. Embodiments may be helpful for tenant-specific anomaly detection by generating a novel combination of tenant vectors and using them to enhance the context of the sequential time series sequences. Embodiments may avoid the use of multiple neural networks (one per tenant) and save computing resources both in terms of training and production runs. This would also avoid a lot of operational overhead, because only a single model needs to be operated upon. Embodiments described herein can be useful for products such as API Management, API Hub, Cloud Platform, etc.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

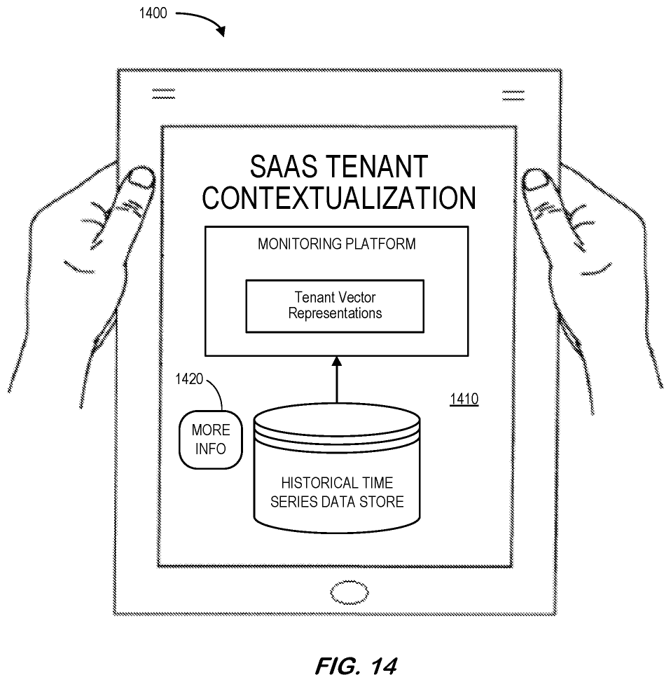

Although specific hardware and data configurations have been described herein, note that any number of other configurations may be provided in accordance with some embodiments of the present invention (e.g., some of the data associated with the databases described herein may be combined or stored in external systems). Moreover, although some embodiments are focused on particular types of application errors and responses to those errors (e.g., restarting a SaaS application, adding resources), any of the embodiments described herein could be applied to other types of application errors and responses. Moreover, the displays shown herein are provided only as examples, and any other type of user interface could be implemented. For example, FIG. 14 shows a handheld tablet computer 1400 rendering a SaaS tenant contextualization display 1410 that may be used to view or adjust existing system framework components and/or to request additional data (e.g., via a “More Info” icon 1420).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with a multi-tenant cloud computing environment, comprising:
a historical time series data store containing electronic records associated with Software-as-a-Service (“SaaS”) applications in the multi-tenant cloud computing environment, each electronic record including time series data representing execution of the SaaS applications; and
a monitoring platform, coupled to a monitored SaaS application currently executing in the multi-tenant cloud computing environment for a plurality of tenants, including:
a computer processor, and
a computer memory coupled to the computer processor and storing instructions that, when executed by the computer processor, cause the monitoring platform to:
(i) retrieve time series data for the monitored SaaS application from the historical time series data store,
(i) create tenant vector representations associated with the retrieved time series data,
(iii) provide the retrieved time series data and tenant vector representations together as final input vectors to an autoencoder to produce an output including at least one of a tenant-specific loss reconstruction and tenant-specific thresholds for the monitored SaaS application, and
(iv) utilize the output of the autoencoder to automatically detect an anomaly associated with the monitored SaaS application.

2. The system of claim 1, wherein the autoencoder comprises a Long Short-Term Memory (“LSTM”) autoencoder.

3. The system of claim 1, wherein the creation of the tenant vector representations is performed using one-hot encoding.

4. The system of claim 1, wherein the creation of the tenant vector representations is performed using a tenant-to-vector algorithm.

5. The system of claim 4, wherein the tenant-to-vector algorithm is associated with at least one of: (i) an account identifier, (ii) a sub-account identifier, (iii) revenue information, and (iv) usage data.

6. The system of claim 1, wherein a length of the tenant vector representations equals a length of the time series data.

7. The system of claim 1, wherein the monitoring platform is further configured to transmit an anomaly detection signal based on the tenant-specific thresholds.

8. The system of claim 1, wherein the output of the autoencoder is associated with at least one of: (i) trends, (ii) seasonality, (iii) usage cycles, and (iv) peak usage time periods.

9. The system of claim 1, wherein the output of the autoencoder is associated with predictions about future times series data for the monitored SaaS application.

10. The system of claim 9, wherein the predictions about future times series data for the monitored SaaS application are used to allocate resources of the multi-tenant cloud computing environment.

11. A computer-implemented method associated with a multi-tenant cloud computing environment, comprising:
retrieving, by a computer processor of a monitoring platform, time series data representing execution of Software-as-a-Service (“SaaS”) applications in the multi-tenant cloud computing environment;
creating tenant vector representations associated with the retrieved time series data;
providing the retrieved time series data and tenant vector representations together as final input vectors to an autoencoder to produce an output including at least one of a tenant-specific loss reconstruction and tenant-specific thresholds for the monitored SaaS application; and
utilizing the output of the autoencoder to automatically detect an anomaly associated with the monitored SaaS application.

12. The method of claim 11, wherein the autoencoder comprises a Long Short-Term Memory (“LSTM”) autoencoder.

13. The method of claim 11, wherein the creation of the tenant vector representations is performed using one-hot encoding.

14. The method of claim 11, wherein the creation of the tenant vector representations is performed using a tenant-to-vector algorithm.

15. The method of claim 14, wherein the tenant-to-vector algorithm is associated with at least one of: (i) an account identifier, (ii) a sub-account identifier, (iii) revenue information, and (iv) usage data.

16. The method of claim 11, wherein a length of the tenant vector representation equals a length of the time series data.

17. A system comprising:
at least one programmable processor; and
a non-transitory machine-readable medium storing instructions that, when executed by the at least one programmable processor, cause the at least one programmable processor to perform operations including:
retrieving time series data representing execution of Software-as-a-Service (“SaaS”) applications in a multi-tenant cloud computing environment,
creating tenant vector representations associated with the retrieved time series data,
providing the retrieved time series data and tenant vector representations together as final input vectors to an autoencoder to produce an output including at least one of a tenant-specific loss reconstruction and tenant-specific thresholds for the monitored SaaS application, and
utilizing the output of the autoencoder to automatically detect an anomaly associated with the monitored SaaS application.

18. The system of claim 17, wherein execution of the instructions further cause the at least one programmable processor to transmit an anomaly detection signal based on the tenant-specific thresholds.

19. The system of claim 17, wherein the output of the autoencoder is associated with at least one of: (i) trends, (ii) seasonality, (iii) usage cycles, and (iv) peak usage time periods.

20. The system of claim 17, wherein the output of the autoencoder is associated with predictions about future times series data for the monitored SaaS application.

21. The system of claim 20, wherein the predictions about future times series data for the monitored SaaS application are used to allocate resources of the multi-tenant cloud computing environment.
